(19) United States
(12) Patent Application Publication
(10) Pub. No.: US 2025/0174860 A1
(43) Pub. Date: May 29, 2025

(54) LOGIC BASED INEGRATED SELF-CONTAINED DRAIN VALVE

(71) Applicant: GM Global Technology Operations LLC, Detroit, MI (US)

(72) Inventors: Kevin James Lapprich, Sterling Heights, MI (US); Sara Arendell, Waterford, MI (US)

(21) Appl. No.: 18/519,306

(22) Filed: Nov. 27, 2023

(51) Int. Cl. H01M 50/691; B60L 50/64; B60R 16/03; H01M 10/48

(52) U.S. Cl. CPC H01M 50/691; B60L 50/64; B60R 16/03; H01M 10/48; H01M 2220/20

(57) ABSTRACT

A vehicle includes a battery pack having a drain assembly. The battery pack is disposed within a housing. The drain assembly includes a conduit extending from a first end located within a housing of the battery pack to a second end outside of the housing. A valve within the conduit controls flow of a first fluid from the first end to the second end. An exterior sensor located exterior to the housing detects a presence of a second fluid outside of the housing. A processor places the valve in a closed state when the exterior sensor determines the presence of the second fluid to prevent the second fluid from flowing into the housing.

The subject disclosure relates to the maintenance of a battery pack used in a vehicle and, in particular, to a drain valve for the battery pack.

A battery pack is used in a vehicle to provide power to the vehicle. A fluid in the battery pack can impair operation of the battery pack and can accelerate a thermal runaway event in the battery pack. A drain assembly is used to allow any fluids in the battery pack to drain out. However, when the vehicle is in a wet surrounding or environment, the drain assembly can unintentionally allow fluids into the battery pack. Accordingly, it is desirable to provide a drain assembly that allows fluid inside the battery pack to flow out of the battery pack while preventing fluids outside of the battery pack from entering the battery pack.

### SUMMARY

In one exemplary embodiment, a drain assembly for a battery pack of a vehicle is disclosed. The drain assembly includes a conduit extending from a first end located within a housing of the battery pack to a second end outside of the housing, a valve within the conduit for controlling flow of a first fluid from the first end to the second end, an exterior sensor located exterior to the housing for detecting a presence of a second fluid outside of the housing, and a processor configured to place the valve in a closed state when the exterior sensor determines the presence of the second fluid to prevent the second fluid from flowing into the housing.

In addition to one or more of the features described herein, the exterior sensor is disposed proximate the second end of the conduit.

In addition to one or more of the features described herein, the drain assembly further includes an interior sensor for detecting the first fluid interior to the housing.

In addition to one or more of the features described herein, the processor is configured to open the valve when the interior sensor indicates the presence of the first fluid in the housing and the exterior sensor indicates the second fluid is not present outside of the housing.

In addition to one or more of the features described herein, the processor is powered by one of a dedicated battery and the battery pack.

In addition to one or more of the features described herein, the exterior sensor is disposed along an outer wall of the conduit.

In addition to one or more of the features described herein, the processor is further configured to send a signal to a vehicle diagnostics circuit of the vehicle when the first fluid is detected.

In another exemplary embodiment, a battery pack for a vehicle is disclosed. The battery pack includes a housing, a conduit extending from a first end located within the housing to a second end outside of the housing, a valve within the conduit for controlling flow of a first fluid from the first end to the second end, an exterior sensor located exterior to the housing for detecting a presence of a second fluid outside of the housing, and a processor configured to close the valve when the exterior sensor determines the presence of the second fluid outside the housing to prevent the second fluid from flowing into the housing.

In addition to one or more of the features described herein, the exterior sensor is disposed proximate the second end of the conduit.

In addition to one or more of the features described herein, the battery pack further includes an interior sensor for detecting the first fluid interior to the housing.

In addition to one or more of the features described herein, the processor is configured to open the valve when the interior sensor indicates the presence of the first fluid in the housing and the exterior sensor indicates the second fluid is not present outside of the housing.

In addition to one or more of the features described herein, the processor is powered by one of a dedicated battery and the battery pack.

In addition to one or more of the features described herein, the exterior sensor is disposed along an outer wall of the conduit.

In addition to one or more of the features described herein, the processor is further configured to send a signal to a vehicle diagnostics circuit of the vehicle when the first fluid is detected.

In yet another exemplary embodiment, a vehicle is disclosed. The vehicle includes a battery pack disposed within a housing, a conduit extending from a first end located within the housing to a second end outside of the housing, a valve within the conduit for controlling flow of a first fluid from the first end to the second end, an exterior sensor located exterior to the housing for detecting a presence of a second fluid outside of the housing, and a processor configured to close the valve when the exterior sensor determines the presence of the second fluid outside the housing to prevent the second fluid from flowing into the housing.

In addition to one or more of the features described herein, the exterior sensor is disposed proximate the second end of the conduit.

In addition to one or more of the features described herein the vehicle further includes an interior sensor for detecting the first fluid interior to the housing and the processor is configured to open the valve when the interior sensor indicates the presence of the first fluid in the housing and the exterior sensor indicates the second fluid is not present outside of the housing.

In addition to one or more of the features described herein, the processor is powered by one of a dedicated battery and the battery pack.

In addition to one or more of the features described herein, the exterior sensor is disposed along an outer wall of the conduit.

In addition to one or more of the features described herein, the processor is further configured to send a signal to a vehicle diagnostics circuit of the vehicle when the first fluid is detected.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows an embodiment of a vehicle, in accordance with an exemplary embodiment;

FIG. 2 shows a side view of a battery pack of the vehicle, in an illustrative embodiment; and

FIG. 3 shows a side view of the drain assembly, in an illustrative embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features.

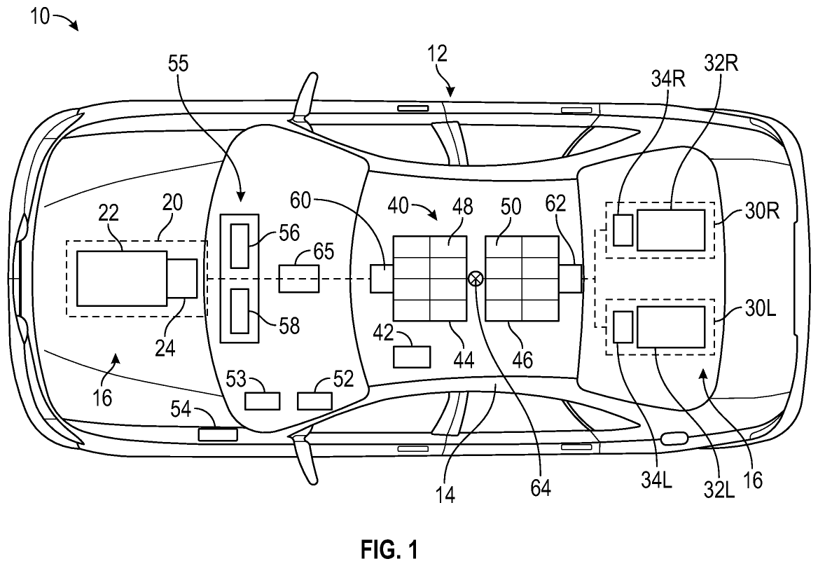

In accordance with an exemplary embodiment, FIG. 1 shows an embodiment of a vehicle 10, which includes a vehicle body 12 defining, at least in part, an occupant compartment 14. The vehicle body 12 also supports various vehicle subsystems including a propulsion system 16, and other subsystems to support functions of the propulsion system 16 and other vehicle components, such as a braking subsystem, a suspension system, a steering subsystem, and others.

The vehicle 10 may be an electrically powered vehicle (EV), a hybrid vehicle or any other vehicle. In an embodiment, the vehicle 10 is an electric vehicle that includes multiple motors and/or drive systems. Any number of drive units may be included, such as one or more drive units for applying torque to front wheels (not shown) and/or to rear wheels (not shown). The drive units are controllable to operate the vehicle 10 in various operating modes, such as a normal mode, a high-performance mode (in which additional torque is applied), all-wheel drive (“AWD”), front-wheel drive (“FWD”), rear-wheel drive (“RWD”) and others.

For example, the propulsion system 16 is a multi-drive system that includes a front drive unit 20 for driving front wheels, and rear drive units for driving rear wheels. The front drive unit 20 includes a front electric motor 22 and a front inverter 24 (e.g., front power inverter module or FPIM), as well as other components such as a cooling system. A left rear drive unit 30L includes a left rear electric motor 32L and a left rear inverter 34L. A right rear drive unit 30R includes a right rear electric motor 32R and a right rear inverter 34R. The front inverter 24, left rear inverter 34L and right rear inverter 34R (e.g., power inverter units or PIMs) each convert direct current (DC) power from a high voltage (HV) battery system 40 to poly-phase (e.g., two-phase, three-phase, six-phase, etc.) alternating current (AC) power to drive the front electric motor 22 the left rear electric motor 32L and the right rear electric motor 32R.

As shown in FIG. 1, the drive systems feature separate electric motors. However, embodiments are not so limited. For example, instead of separate motors, multiple drives can be provided by a single machine that has multiple sets of windings that are physically independent.

As also shown in FIG. 1, the drive systems are configured such that the front electric motor 22 drives the front wheels (not shown), and the left rear electric motor 32L and right rear electric motor 32R drive the rear wheels (not shown). However, embodiments are not so limited, as there may be any number of drive systems and/or motors at various locations (e.g., a motor driving each wheel, twin motors per axle, etc.). In addition, embodiments are not limited to a dual drive system, as embodiments can be used with a vehicle having any number of motors and/or power inverters.

In the propulsion system 16, the front drive unit 20, left rear drive unit 30L and right rear drive unit 30R are electrically connected to a battery system 40. The battery system 40 may also be electrically connected to other electrical components (also referred to as “electrical loads”), such as vehicle electronics (e.g., via an auxiliary power module or APM 42), heaters, cooling systems and others. The battery system 40 may be configured as a rechargeable energy storage system (RESS).

In an embodiment, the battery system 40 includes a plurality of separate battery assemblies, in which each battery assembly can be independently charged and can be used to independently supply power to a drive system or systems. For example, the battery system 40 includes a first battery assembly such as a first battery pack 44 connected to the front inverter 24, and a second battery pack 46. The first battery pack 44 includes a plurality of battery modules 48, and the second battery pack 46 includes a plurality of battery modules 50. Each battery module 48, 50 includes a number of individual cells (not shown). In various embodiments, one or more of the battery packs can include a MODACS (Multiple Output Dynamically Adjustable Capacity) battery.

Each of the front electric motor 22 and the left rear electric motor 32L and right rear electric motor 32R is a three-phase motor having three phase motor windings. However, embodiments described herein are not so limited. For example, the motors may be any poly-phase machines supplied by poly-phase inverters, and the drive units can be realized using a single machine having independent sets of windings.

The battery system 40 and/or the propulsion system 16 includes a switching system having various switching devices for controlling operation of the first battery pack 44 and second battery pack 46, and selectively connecting the first battery pack 44 and second battery pack 46 to the front drive unit 20, left rear drive unit 30L and right rear drive unit 30R. The switching devices may also be operated to selectively connect the first battery pack 44 and the second battery pack 46 to a charging system. The charging system can be used to charge the first battery pack 44 and the second battery pack 46, and/or to supply power from the first battery pack 44 and/or the second battery pack 46 to charge another energy storage system (e.g., vehicle-to-vehicle (V2V) and/or vehicle-to-everything (V2X) charging). The charging system includes one or more charging modules. For example, a first onboard charging module (OBCM) 52 is electrically connected to a charge port 54 for charging to and from an AC system or device, such as a utility AC power supply. A second OBCM 53 may be included for DC charging (e.g., DC fast charging or DCFC).

In an embodiment, the switching system includes a first switching device 60 that selectively connects to the first battery pack 44 to the front inverter 24, left rear inverter 34L and right rear inverter 34R, and a second switching device 62 that selectively connects the second battery pack 46 to the front inverter 24, left rear inverter 34L and right rear inverter 34R. The switching system also includes a third switching device 64 (also referred to as a “battery switching device”) for selectively connecting the first battery pack 44 to the second battery pack 46 in series.

Any of various controllers can be used to control functions of the battery system 40, the switching system and the drive units. A controller includes any suitable processing device or unit, and may use an existing controller such as a drive system controller, an RESS controller, and/or controllers in the drive system. For example, a controller 65 may be included for controlling switching and drive control operations as discussed herein.

The vehicle 10 also includes a computer system 55 that includes one or more processing devices 56 and a user interface 58. The computer system 55 may communicate with the charging system controller, for example, to provide commands thereto in response to a user input. The various processing devices, modules and units may communicate with one another via a communication device or system, such as a controller area network (CAN) or transmission control protocol (TCP) bus.

As illustrated herein, the vehicle 10 is an electric vehicle. In an alternative embodiment, the vehicle 10 can be an internal combustion engine vehicle, a hybrid vehicle, etc.

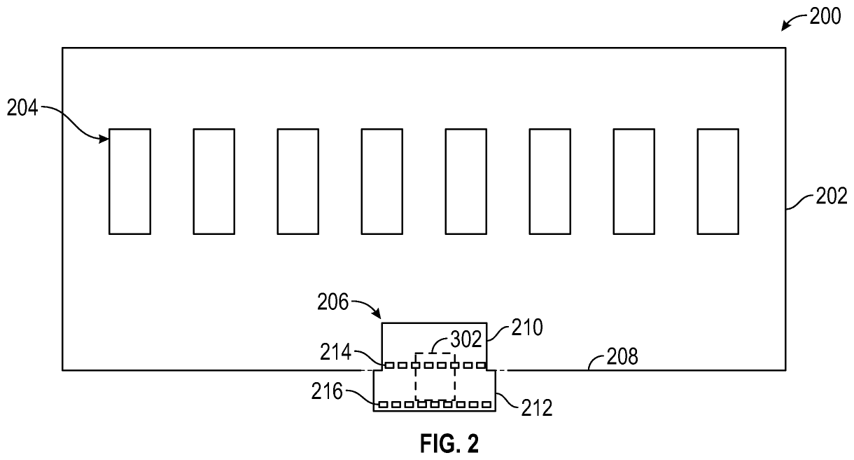

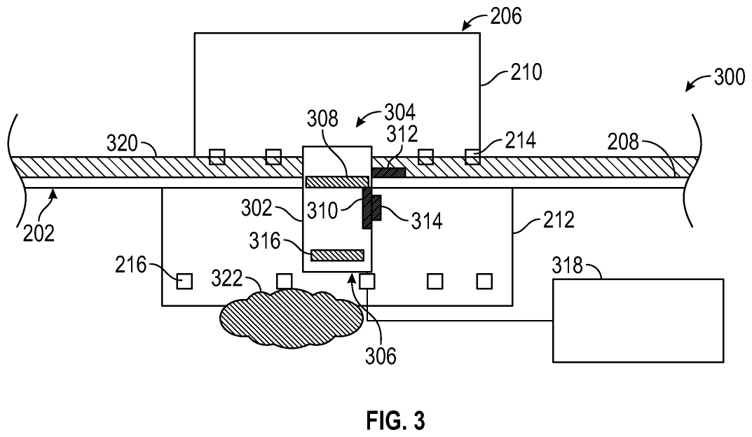

FIG. 2 shows a side view of a battery pack 200 of the vehicle 10, in an illustrative embodiment. The battery pack 200 includes a housing 202 and one or more battery cells 204 within the housing 202 for providing power to the vehicle 10. A drain assembly 206 is located at a surface 208 of the housing 202 and allows aqueous fluids and gases (such as water, coolant, electrolytic fluid and any fluid containing waste products from operation of the one or more battery cells 204) to be drained from the housing 202. The surface 208 can be a bottom surface of the housing 202 or a side surface or top surface of the housing, in various embodiments. The drain assembly 206 includes a first section 210 that is disposed inside the housing 202 and a second section 212 that is disposed outside the housing 202. The first section 210 includes one or more inlets 214 and the second section 212 includes one or more outlets 216. A fluid path inside the drain assembly 206 connects the one or more inlets 214 of the first section 210 to the one or more outlets 216 of the second section 212, as shown in FIG. 3.

FIG. 3 shows a sectional view 300 of the drain assembly 206 in an illustrative embodiment. The drain assembly 206 includes a conduit 302 extending between a first end 304 disposed within the housing 202 and a second end 306 disposed outside of the housing. The conduit 302 includes a fluid path through which a fluid can flow. A drain valve 308 is disposed within the conduit 302. The drain assembly 206 includes a valve controller 310. The valve controller 310 may include processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality. The valve controller 310 may include a non-transitory computer-readable medium that stores instructions which, when processed by one or more processors of the valve controller 310, implement a method of controller operation of the drain assembly 206 according to one or more embodiments detailed herein.

The valve controller 310 includes an integrated sensing circuit that is coupled to the drain valve 308 and controls the drain valve 308 to switch between an open state and a closed state. The valve controller 310 is connected to an interior sensor 312 and an exterior sensor 314. The interior sensor 312 is located on an inside of the housing 202. The interior sensor 312 can be located near the one or more inlets 214 of the drain assembly 206. The interior sensor 312 detects a presence of a first fluid 320 within the housing 202 and sends a signal to the valve controller 310 to indicate this presence. The exterior sensor 314 is located outside of the housing 202. In various embodiments, the exterior sensor 314 is located near the second end 306 of the conduit 302. The exterior sensor 314 can be disposed along an outer wall of the conduit 302. The exterior sensor 314 detects a presence of a second fluid 322 outside of the housing 202, especially near the one or more outlets 216 of the drain assembly 206 (i.e., any location from which it is possible that the second fluid 322 can travel through the fluid path of the conduit 302 and into the housing 202). The exterior sensor 314 sends a signal to the valve controller 310 when the second fluid 322 is detected.

The processor of the valve controller 310 allows the drain valve 308 to be opened when the first fluid 320 is present within the housing 202 (e.g., at the surface 208 inside the housing). However, if a second fluid 322 is present on the outside of the housing 202, whether the first fluid 320 is present or not, the processor places the drain valve 308 in a closed state, either by closing the valve (if the valve is in an open state) or by maintaining the valve in the closed state. Once the second fluid 322 is removed or is no longer present, the processor can open the valve to allow any of the first fluid 320 to drain out of the housing 202. The processor thereby prevents the second fluid 322 from entering the housing 202 and the battery pack, while allowing the first fluid 320 to drain when conditions have changed and the second fluid 322 is no longer present.

In one embodiment, a dedicated battery 316, such as a cell battery, a +5-volt battery, etc., can be used to power the integrated sensing circuit. In another embodiment, the integrated sensing circuit can be powered by the battery pack or another battery pack.

The integrated sensing circuit is in communication with a vehicle diagnostics circuit 318, such as a display at a dashboard. The valve controller 310 detects the presence of the first fluid 320 and sends a signal to the vehicle diagnostics circuit 318 to alert others, such as a driver of the vehicle, of the presence of the first fluid 320. This alert can allow the driver to recognize the need to service the battery pack. The vehicle diagnostics circuit 318 can also perform various actions to mitigate problems, such as reducing a propulsion of the vehicle or eliminating use of the battery pack.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A drain assembly for a battery pack of a vehicle, comprising:
a conduit extending from a first end located within a housing of the battery pack to a second end outside of the housing;
a valve within the conduit for controlling flow of a first fluid from the first end to the second end;
an exterior sensor located exterior to the housing for detecting a presence of a second fluid outside of the housing; and
a processor configured to place the valve in a closed state when the exterior sensor determines the presence of the second fluid to prevent the second fluid from flowing into the housing.

2. The drain assembly of claim 1, wherein the exterior sensor is disposed proximate the second end of the conduit.

3. The drain assembly of claim 1, further comprising an interior sensor for detecting the first fluid interior to the housing.

4. The drain assembly of claim 3, wherein the processor is configured to open the valve when the interior sensor indicates the presence of the first fluid in the housing and the exterior sensor indicates the second fluid is not present outside of the housing.

5. The drain assembly of claim 1, wherein the processor is powered by one of: (i) a dedicated battery; and (ii) the battery pack.

6. The drain assembly of claim 1, wherein the exterior sensor is disposed along an outer wall of the conduit.

7. The drain assembly of claim 1, wherein the processor is further configured to send a signal to a vehicle diagnostics circuit of the vehicle when the first fluid is detected.

8. A battery pack for a vehicle, comprising:
a housing;
a conduit extending from a first end located within the housing to a second end outside of the housing;
a valve within the conduit for controlling flow of a first fluid from the first end to the second end;
an exterior sensor located exterior to the housing for detecting a presence of a second fluid outside of the housing; and
a processor configured to close the valve when the exterior sensor determines the presence of the second fluid outside the housing to prevent the second fluid from flowing into the housing.

9. The battery pack of claim 8, wherein the exterior sensor is disposed proximate the second end of the conduit.

10. The battery pack of claim 8, further comprising an interior sensor for detecting the first fluid interior to the housing.

11. The battery pack of claim 10, wherein the processor is configured to open the valve when the interior sensor indicates the presence of the first fluid in the housing and the exterior sensor indicates the second fluid is not present outside of the housing.

12. The battery pack of claim 8, wherein the processor is powered by one of: (i) a dedicated battery; and (ii) the battery pack.

13. The battery pack of claim 8, wherein the exterior sensor is disposed along an outer wall of the conduit.

14. The battery pack of claim 8, wherein the processor is further configured to send a signal to a vehicle diagnostics circuit of the vehicle when the first fluid is detected.

15. A vehicle, comprising:
a battery pack disposed within a housing;
a conduit extending from a first end located within the housing to a second end outside of the housing;
a valve within the conduit for controlling flow of a first fluid from the first end to the second end;
an exterior sensor located exterior to the housing for detecting a presence of a second fluid outside of the housing; and
a processor configured to close the valve when the exterior sensor determines the presence of the second fluid outside the housing to prevent the second fluid from flowing into the housing.

16. The vehicle of claim 15, wherein the exterior sensor is disposed proximate the second end of the conduit.

17. The vehicle of claim 15, further comprising an interior sensor for detecting the first fluid interior to the housing, wherein the processor is configured to open the valve when the interior sensor indicates the presence of the first fluid in the housing and the exterior sensor indicates the second fluid is not present outside of the housing.

18. The vehicle of claim 15, wherein the processor is powered by one of: (i) a dedicated battery; and (ii) the battery pack.

19. The vehicle of claim 15, wherein the exterior sensor is disposed along an outer wall of the conduit.

20. The vehicle of claim 15, wherein the processor is further configured to send a signal to a vehicle diagnostics circuit of the vehicle when the first fluid is detected.
